(19) United States
(12) Patent Application Publication
(10) Pub. No.: US 2026/0086260 A1
(43) Pub. Date: Mar. 26, 2026

(54) ELECTRICAL SOURCE TRANSIENT ELECTROMAGNETIC DATA IMAGING METHOD, DEVICE AND SYSTEM THEREOF AND STORAGE MEDIUM

(71) Applicant: Institute of Geology and Geophysics, Chinese Academy of Sciences, Beijing (CN)

(72) Inventors: Weiying CHEN, Beijing (CN); Guoqiang XUE, Beijing (CN); Yulian ZHU, Beijing (CN); Pengfei LYU, Beijing (CN)

(21) Appl. No.: 19/266,349

(22) Filed: Jul. 11, 2025

(30) Foreign Application Priority Data
Sep. 20, 2024 (CN) 202411314431.5

(51) Int. Cl. G01V 3/12; G01V 3/38; G01V 20/00

(52) U.S. Cl. CPC G01V 3/12; G01V 3/38; G01V 20/00

(57) ABSTRACT

An electrical source transient electromagnetic data imaging method, a device and a system thereof and a storage medium are provided. The method includes following steps: step S1, observing horizontal electric field eₓ and vertical induced voltage v_{z} at a same measuring point; step S2, respectively obtaining first derivatives of time t for the horizontal electric field eₓ and the vertical induced voltage v_{z}; step S3, calculating full-period apparent resistivity according to the first derivatives; and step S4, performing time-depth conversion according to the full-period apparent resistivity to realize apparent resistivity depth imaging.

### CROSS-REFERENCE TO RELATED APPLICATIONS

This application claims priority to Chinese Patent Application No. 202411314431.5, filed on Sep. 20, 2024, the contents of which are hereby incorporated by reference.

### TECHNICAL FIELD

The disclosure belongs to the technical field of geophysical exploration, and in particular to an electrical source transient electromagnetic data imaging method, a device and a system thereof and a storage medium.

### BACKGROUND

The electrical source transient electromagnetic method uses a long wire with two ends grounded as the emission source, and observes the secondary electromagnetic field signals in a certain range on both sides of the wire, and then obtains the electrical structure in a certain depth range by using data processing methods such as imaging or inversion. Apparent resistivity-depth imaging is a fast and convenient data processing method, in which the key step is the calculation of full-period apparent resistivity. The conventional calculation method of full-period apparent resistivity requires a monotonic relationship between field value and resistivity, so it may only be calculated based on Bz component of vertical magnetic field. However, the actual observed components of the electrical source transient electromagnetic method are mostly horizontal electric field eₓ and vertical induced voltage v_{z}. However, these two components have a binary relationship with resistivity, so it is impossible to calculate the full-period apparent resistivity directly based on the two components. At the same time, it is necessary to strictly consider the actual shape and configuration of the emission source when calculating the full-period apparent resistivity based on the Bz component. When the emission source bends or fluctuates, it will have a great influence on the accuracy of the full-period apparent resistivity results.

### SUMMARY

The technical problem to be solved by the present disclosure is to provide an electrical source transient electromagnetic data imaging method, a device and a system thereof and a storage medium, which may significantly improve the imaging accuracy and convenience of the electrical source transient electromagnetic method.

In order to achieve the above purposes, the present disclosure adopts the following technical schemes.

An electrical source transient electromagnetic data imaging method, including:
step S1, observing horizontal electric field eₓ and vertical induced voltage v_{z} at a same measuring point;
step S2, respectively obtaining first derivatives of time t for the horizontal electric field eₓ and the vertical induced voltage v_{z};
step S3, calculating full-period apparent resistivity according to the first derivatives; and
step S4, performing time-depth conversion according to the full-period apparent resistivity to realize apparent resistivity depth imaging.

Optionally, in the step S2, expressions of the horizontal electric field eₓ and the vertical induced voltage v_{z} are:

$$\begin{matrix}{e}_{x} = \frac{Ids}{{π}^{3 / 2}} \cdot \frac{ρ}{{r}^{3}} \cdot [ \int \text{?} e \text{?} dt - ue \text{?} ] \\ {v}_{z} = - \frac{Ids}{{π}^{3 / 2} {μ}_{0}} \cdot \frac{y ρ}{{r}^{5}} \cdot [ 3 \int \text{?} e \text{?} dt - u ( 3 + 2 {u}^{2} ) e \text{?} ] ,\end{matrix}$$

$$\text{?} \text{indicates text missing or illegible when filed}$$

where I is emission current intensity, ds is a length of a dipole source, ρ is resistivity, r=\sqrt{(x−x′)²+(y−y′)²} is a distance from an observation point (x, y) to an emission source (x′, y′), and a variable

$$u = \frac{1}{2} \sqrt{\frac{{μ}_{0}}{ρ t}} r ,$$

μ₀=4×10⁻⁷ henry per ampere (H/A) is magnetic permeability.

The first derivatives of the time t are respectively obtained for the eₓ and the v_{z}:

$$\begin{matrix}{\dot{e}}_{x} = \frac{\partial {e}_{x}}{\partial t} = \frac{Ids}{{π}^{3 / 2}} \cdot \frac{ρ}{{r}^{3}} \cdot \frac{1}{t} \cdot {u}^{3} \cdot {e}^{- {u}^{2}} \\ {\dot{v}}_{z} = \frac{\partial {v}_{z}}{\partial t} = \frac{Ids}{{π}^{3 / 2} {μ}_{0}} \cdot \frac{y ρ}{{r}^{5}} \cdot 2 {u}^{5} \cdot {e}^{- {u}^{2}} \cdot \frac{1}{t} .\end{matrix}$$

Optionally, in the step S3, full-period resistivity is calculated by using a ratio of the ėₓ to the \dot{v}_{z},

$$ρ = \frac{y}{2 t} \cdot \vert \frac{{\dot{e}}_{x}}{{\dot{v}}_{z}} \vert .$$

The present disclosure also provides an electrical source transient electromagnetic data imaging device, including:
an acquisition module used for observing horizontal electric field eₓ and vertical induced voltage v_{z} at a same measuring point;
a first calculation module used for respectively obtaining a first derivative of time t for the horizontal electric field eₓ and the vertical induced voltage v_{z};
a second calculation module used for calculating full-period apparent resistivity according to the first derivative; and
a third calculation module used for performing time-depth conversion according to the full-period apparent resistivity to realize apparent resistivity depth imaging.

Optionally, expressions of the horizontal electric field eₓ and the vertical induced voltage v_{z} are:

$$\begin{matrix}{e}_{x} = \frac{Ids}{{π}^{3 / 2}} \cdot \frac{ρ}{{r}^{3}} \cdot [ \int \text{?} e \text{?} dt - ue \text{?} ] \\ {v}_{z} = - \frac{Ids}{{π}^{3 / 2} {μ}_{0}} \cdot \frac{y ρ}{{r}^{5}} \cdot [ 3 \int \text{?} e \text{?} dt - u ( 3 + 2 {u}^{2} ) e \text{?} ] ,\end{matrix}$$

$$\text{?} \text{indicates text missing or illegible when filed}$$

where I is emission current intensity, ds is a length of a dipole source, ρ is resistivity, r=\sqrt{(x−x′)²+(y−y′)²} is a distance from an observation point (x, y) to an emission source (x′, y′), and a variable

$$u = \frac{1}{2} \sqrt{\frac{{μ}_{0}}{ρ t}} r ,$$

μ₀=4×10⁻⁷ H/A is magnetic permeability; and
the first derivative of the time t is respectively obtained for the eₓ and the v_{z}:

$$\begin{matrix}{\dot{e}}_{x} = \frac{\partial {e}_{x}}{\partial t} = \frac{Ids}{{π}^{3 / 2}} \cdot \frac{ρ}{{r}^{3}} \cdot \frac{1}{t} \cdot {u}^{3} \cdot {e}^{- {u}^{2}} \\ {\dot{v}}_{z} = \frac{\partial {v}_{z}}{\partial t} = \frac{Ids}{{π}^{3 / 2} {μ}_{0}} \cdot \frac{y ρ}{{r}^{5}} \cdot 2 {u}^{5} \cdot {e}^{- {u}^{2}} \cdot \frac{1}{t} .\end{matrix}$$

Optionally, the second calculation module uses a ratio of the ėₓ to the \dot{v}_{z} to calculate the full-period apparent resistivity,

$$ρ = \frac{y}{2 t} \cdot \vert \frac{{\dot{e}}_{x}}{{\dot{v}}_{z}} \vert .$$

The disclosure also provides an electrical source transient electromagnetic data imaging system, including a memory and a processor, where a computer program run by the processor is stored in the memory, and the computer program executes the electrical source transient electromagnetic data imaging method when the computer program is run by the processor.

The disclosure also provides a storage medium, where a computer program is stored on the storage medium, and the computer program executes the electrical source transient electromagnetic data imaging method when running.

The disclosure may directly utilize the eₓ and v_{z} components measured in the field, and eliminate the influence of the emission source, significantly improving the imaging accuracy and convenience of the electrical source transient electromagnetic method.

### BRIEF DESCRIPTION OF THE DRAWINGS

In order to clearly explain the embodiments of the present disclosure or the technical schemes in the prior art, the drawings needed in the description of the embodiments or the prior art will be briefly introduced below. Obviously, the drawings in the following description are only the embodiments of the present disclosure. For ordinary technicians in the field, other drawings may be obtained according to the provided drawings without creative labor.

FIG. 1 shows a flow chart of an electrical source transient electromagnetic data imaging method according to an embodiment of the present disclosure.

FIG. 2 shows the imaging results of a numerical case.

FIG. 3 shows the imaging results of measured data.

### DETAILED DESCRIPTION OF THE EMBODIMENTS

In the following, the technical schemes in the embodiments of the disclosure will be clearly and completely described with reference to the attached drawings. Obviously, the described embodiments are only a part of the embodiments of the disclosure, but not the whole embodiments. Based on the embodiments in the present disclosure, all other embodiments obtained by ordinary technicians in the field without creative labor belong to the scope of protection of the present disclosure.

In order to make the above-mentioned objects, features and advantages of the present disclosure more obvious and easy to understand, the present disclosure will be further described in detail with the attached drawings and specific embodiments.

### Embodiment 1

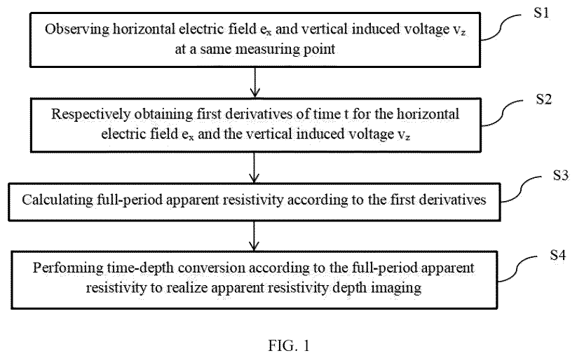

As shown in FIG. 1, an embodiment of the present disclosure provides an electrical source transient electromagnetic data imaging method, including:
step S1, observing horizontal electric field eₓ and vertical induced voltage v_{z} at a same measuring point;
step S2, respectively obtaining first derivatives of time t for the horizontal electric field eₓ and the vertical induced voltage v_{z};
step S3, calculating full-period apparent resistivity according to the first derivatives; and
step S4, performing time-depth conversion according to the full-period apparent resistivity to realize apparent resistivity depth imaging.

As an implementation of the embodiment of the present disclosure, in the step S2, expressions of the horizontal electric field eₓ and the vertical induced voltage v_{z} are:

$$\begin{matrix}{e}_{x} = \frac{Ids}{{π}^{3 / 2}} \cdot \frac{ρ}{{r}^{3}} \cdot [ \int \text{?} e \text{?} dt - ue \text{?} ] \\ {v}_{z} = - \frac{Ids}{{π}^{3 / 2} {μ}_{0}} \cdot \frac{y ρ}{{r}^{5}} \cdot [ 3 \int \text{?} e \text{?} dt - u ( 3 + 2 {u}^{2} ) e \text{?} ] ,\end{matrix}$$

$$\text{?} \text{indicates text missing or illegible when filed}$$

where I is emission current intensity, ds is a length of a dipole source, ρ is resistivity, r=\sqrt{(x−x′)²+(y−y′)²} is a distance from an observation point (x, y) to an emission source (x′, y′), and a variable

$$u = \frac{1}{2} \sqrt{\frac{{μ}_{0}}{ρ t}} r ,$$

μ₀=4×10⁻⁷ henry per ampere (H/A) is magnetic permeability; and
the first derivatives of the time t are respectively obtained for the eₓ and the v_{z}:

$$\begin{matrix}{\dot{e}}_{x} = \frac{\partial {e}_{x}}{\partial t} = \frac{Ids}{{π}^{3 / 2}} \cdot \frac{ρ}{{r}^{3}} \cdot \frac{1}{t} \cdot {u}^{3} \cdot {e}^{- {u}^{2}} \\ {\dot{v}}_{z} = \frac{\partial {v}_{z}}{\partial t} = \frac{Ids}{{π}^{3 / 2} {μ}_{0}} \cdot \frac{y ρ}{{r}^{3}} \cdot 2 {u}^{5} \cdot {e}^{- {u}^{2}} \cdot \frac{1}{t} .\end{matrix}$$

As an implementation of the embodiment of the present disclosure, in the step S3, the ratio of the ėₓ to the \dot{v}_{z} is calculated,

$$\frac{{{e}^{\text{?}}}_{x}}{{{v}^{\text{?}}}_{z}} = \frac{2 t ρ}{y} .$$

$$\text{?} \text{indicates text missing or illegible when filed}$$

From this, the expression of resistivity ρ may be obtained, and in order to ensure that ρ is positive, the absolute value of the ratio of the ėₓ to the \dot{v}_{z} is taken:

$$ρ = \frac{y}{2 t} \cdot \vert \frac{{{e}^{\text{?}}}_{x}}{{{v}^{\text{?}}}_{z}} \vert .$$

$$\text{?} \text{indicates text missing or illegible when filed}$$

As an implementation of the embodiment of the present disclosure, in the step S4, the time-depth conversion is as follows:

$$d ( t ) = 1.2 \sqrt{2 t ρ / {μ}_{0}} .$$

Through the above steps, the full-period apparent resistivity value p corresponding to the depth d(t) may be obtained, and the corresponding relationship between depth and apparent resistivity may be obtained. This process is imaging, from which the resistivity distribution in a certain depth range underground may be obtained, and the apparent resistivity-depth imaging of electrical source transient electromagnetic data may be realized.

In the step S2, the ratio method is used to eliminate the influence of the emission source term Ids, which may significantly improve the calculation accuracy of the full-period apparent resistivity, and make this method suitable for the situation of complex emission source shape affected by terrain and other factors.

A numerical case;

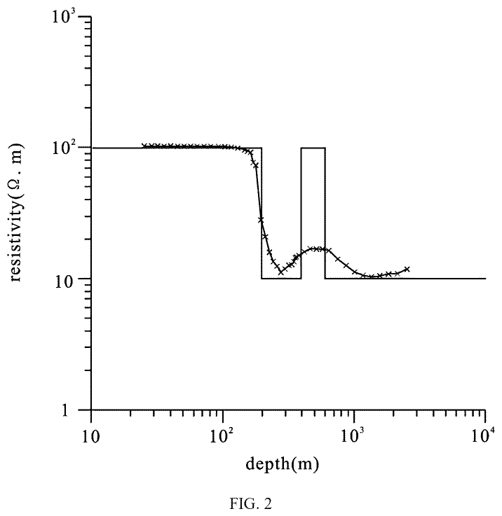

FIG. 2 is an imaging case of a numerical simulation model realized by the embodiment of the disclosure. The model parameters are as follows: a four-layer model with the first layer having a resistivity of 100 ohm meters (Ω·m) and thickness of 200 meters (m), the second layer having a resistivity of 10 Ω·m and thickness of 200 m, the third layer having a resistivity of 100 Ω·m and thickness of 200 m, and the fourth layer having a resistivity of 10 Ω·m with infinite thickness. The emission source length of electrical source transient electromagnetic is 500 m, the emission current is 1 ampere (A), and the offset distance of observation point is 1000 m. As may be seen from FIG. 2, the imaging method of this embodiment may well restore the resistivity distribution of the real model.

A measured case:

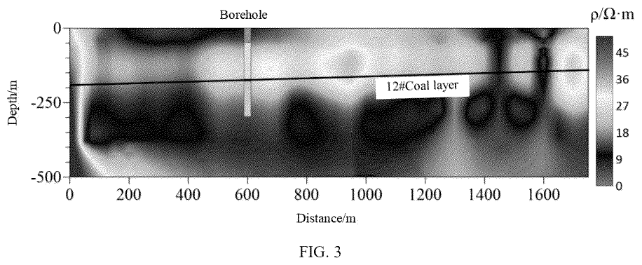

FIG. 3 is an imaging case of measured profile data realized by the embodiment of the disclosure. In this case, the length of the emission source is 1430 m, the emission current is 30 A, the measuring line is parallel to the emission source, and the offset distance is 420 m. As may be seen from FIG. 3, the imaging method of the embodiment of the disclosure may well restore the real earth resistivity distribution, which is in good agreement with the borehole.

### Embodiment 2

The present disclosure also provides an electrical source transient electromagnetic data imaging device, including:
an acquisition module used for observing horizontal electric field eₓ and vertical induced voltage v_{z} at a same measuring point;
a first calculation module used for respectively obtaining first derivatives of time t for the horizontal electric field eₓ and the vertical induced voltage v_{z};
a second calculation module used for calculating full-period apparent resistivity according to the first derivative; and
a third calculation module used for performing time-depth conversion according to the full-period apparent resistivity to realize apparent resistivity depth imaging.

As an implementation of the embodiment of the present disclosure, the expressions of the horizontal electric field eₓ and the vertical induced voltage v_{z} generated by the horizontal electric dipole source on the earth surface in a uniform half space are as follows:

$${e}_{} = - \frac{Ids}{{π}^{3 / 2}} \cdot \frac{ρ}{{r}^{3}} \cdot [ {\int }_{\text{?}}^{\text{?}} {e}^{\text{?}} dt - {ue}^{\text{?}} ]$$

$${v}_{\text{?}} = - \frac{\text{?} ds}{{π}^{3 / 2}} \cdot \frac{y ρ}{{r}^{\text{?}}} \cdot [ 3 {\int }_{\text{?}}^{\text{?}} {e}^{\text{?}} d \text{?} - u ( 3 + 2 {u}^{\text{?}} ) {e}^{\text{?}} ] ,$$

$$\text{?} \text{indicates text missing or illegible when filed}$$

where I is emission current intensity, ds is a length of a dipole source, ρ is resistivity, r=\sqrt{(x−x′)²+(y−y′)²} is a distance from an observation point (x, y) to an emission source (x′, y′), and a variable

$$u = \frac{1}{2} \sqrt{\frac{{μ}_{\text{?}}}{ρ t} r} ,$$

$$\text{?} \text{indicates text missing or illegible when filed}$$

μ₀=4×10⁻⁷ H/A is magnetic permeability; and

the first derivatives of the time t are respectively obtained for the eₓ and the v_{z}:

$${{e}^{\text{?}}}_{\text{?}} = \frac{\partial {e}_{\text{?}}}{\partial t} = \frac{Ids}{{π}^{3 / 2}} \cdot \frac{ρ}{{r}^{3}} \cdot \frac{1}{t} \cdot {u}^{\text{?}} \cdot {e}^{\text{?}}$$

$${{v}^{\text{?}}}_{z} = \frac{\partial {v}_{\text{?}}}{\partial \text{?}} = - \frac{Ids}{{π}^{3 / 2} {μ}_{0}} \cdot \frac{y ρ}{{r}^{5}} \cdot 2 {u}^{\text{?}} \cdot {e}^{\text{?}} \cdot \frac{1}{\text{?}} .$$

$$\text{?} \text{indicates text missing or illegible when filed}$$

As an implementation of the embodiment of the disclosure, the second calculation module uses a ratio of the ėₓ to the \dot{v}_{z} to calculate the full-period apparent resistivity,

$$ρ = \frac{y}{2 t} \cdot \vert \frac{{{e}^{\text{?}}}_{\text{?}}}{{{v}^{\text{?}}}_{\text{?}}} \vert .$$

$$\text{?} \text{indicates text missing or illegible when filed}$$

### Embodiment 3

The embodiment of the disclosure also provides an electrical source transient electromagnetic data imaging system, including a memory and a processor, where a computer program run by the processor is stored in the memory, and the computer program executes the electrical source transient electromagnetic data imaging method when the computer program is run by the processor.

### Embodiment 4

The embodiment of the disclosure also provides a storage medium, where a computer program is stored on the storage medium, and the computer program executes the electrical source transient electromagnetic data imaging method when running.

The embodiments described above are only descriptions of the optional mode of the present disclosure, and are not intended to limit the scope of the present disclosure. Under the premise of not departing from the design spirit of the present disclosure, various modifications and improvements made to the technical schemes of the present disclosure by ordinary technicians in the field shall fall within the scope of protection determined by the claims of the present disclosure.

What is claimed is:

1. An electrical source transient electromagnetic data imaging method, comprising:
step S1, observing horizontal electric field eₓ and vertical induced voltage v_{z} at a same measuring point;
step S2, respectively obtaining first derivatives of time t for the horizontal electric field eₓ and the vertical induced voltage v_{z},
step S3, calculating full-period apparent resistivity according to the first derivatives; and
step S4, performing time-depth conversion according to the full-period apparent resistivity to realize apparent resistivity depth imaging;
wherein in the step S2, expressions of the horizontal electric field eₓ and the vertical induced voltage v_{z} are:
$${e}_{\text{?}} = - \frac{Ids}{{π}^{3 / 2}} \cdot \frac{ρ}{{r}^{3}} \cdot [ {\int }_{\text{?}}^{\text{?}} {e}^{\text{?}} d \text{?} - {ue}^{\text{?}} ]$$
$${v}_{\text{?}} = - \frac{\text{?} ds}{{π}^{3 / 2} {μ}_{\text{?}}} \cdot \frac{y ρ}{{r}^{\text{?}}} \cdot [ 3 {\int }_{\text{?}}^{\text{?}} {e}^{\text{?}} d \text{?} - u ( 3 + 2 {u}^{\text{?}} ) {e}^{\text{?}} ] ,$$
$$\text{?} \text{indicates text missing or illegible when filed}$$
wherein I is emission current intensity, ds is a length of a dipole source, ρ is resistivity, r=\sqrt{(x−x′)²+(y−y′)²} is a distance from an observation point (x, y) to an emission source (x′, y′), and a variable
$$u = \frac{1}{2} \sqrt{\frac{{μ}_{\text{?}}}{ρ \text{?}} r} ,$$
$$\text{?} \text{indicates text missing or illegible when filed}$$
μ₀=4×10⁻⁷ H/A is magnetic permeability; and
the first derivatives of the time t are respectively obtained for the horizontal electric field eₓ and the vertical induced voltage v_{z}:
$${{e}^{\text{?}}}_{\text{?}} = \frac{\partial {e}_{\text{?}}}{\partial t} = \frac{Ids}{{π}^{3 / 2}} \cdot \frac{ρ}{{r}^{3}} \cdot \frac{1}{t} \cdot {u}^{\text{?}} \cdot {e}^{\text{?}}$$
$${{v}^{\text{?}}}_{z} = \frac{\partial {v}_{\text{?}}}{\partial } = - \frac{Ids}{{π}^{3 / 2} {μ}_{0}} \cdot \frac{y ρ}{{r}^{5}} \cdot 2 {u}^{\text{?}} \cdot {e}^{\text{?}} \cdot \frac{1}{\text{?}} ,$$
$$\text{?} \text{indicates text missing or illegible when filed}$$
wherein ėₓ is the first derivative of the time t for the horizontal electric field eₓ, and \dot{v}_{z} is the first derivative of the time t for the vertical induced voltage v_{z}.

2. The electrical source transient electromagnetic data imaging method according to claim 1, wherein in the step S3, full-period resistivity is calculated by using a ratio of the ėₓ to the \dot{v}_{z},
$$ρ = \frac{y}{2 \text{?}} \cdot \vert \frac{{{e}^{\text{?}}}_{\text{?}}}{{{v}^{\text{?}}}_{\text{?}}} \vert .$$
$$\text{?} \text{indicates text missing or illegible when filed}$$

3. An electrical source transient electromagnetic data imaging device, comprising:
an acquisition module used for observing horizontal electric field eₓ and vertical induced voltage v_{z} at a same measuring point;
a first calculation module used for respectively obtaining first derivatives of time t for the horizontal electric field eₓ and the vertical induced voltage v_{z};
a second calculation module used for calculating full-period apparent resistivity according to the first derivatives; and
a third calculation module used for performing time-depth conversion according to the full-period apparent resistivity to realize apparent resistivity depth imaging;
wherein expressions of the horizontal electric field eₓ and the vertical induced voltage v_{z} are:
$${e}_{\text{?}} = - \frac{Ids}{{π}^{3 / 2}} \cdot \frac{ρ}{{r}^{3}} \cdot [ {\int }_{\text{?}}^{\text{?}} {e}^{\text{?}} d \text{?} - {ue}^{\text{?}} ]$$
$${v}_{\text{?}} = - \frac{\text{?} ds}{{π}^{3 / 2} {μ}_{\text{?}}} \cdot \frac{y ρ}{{r}^{\text{?}}} \cdot [ 3 {\int }_{\text{?}}^{\text{?}} {e}^{\text{?}} d \text{?} - u ( 3 + 2 {u}^{\text{?}} ) {e}^{\text{?}} ] ,$$
$$\text{?} \text{indicates text missing or illegible when filed}$$
wherein I is emission current intensity, ds is a length of a dipole source, ρ is resistivity, r=\sqrt{(x−x′)²+(y−y′)²} is a distance from an observation point (x, y) to an emission source (x′, y′), and a variable
$$\text{?} = \frac{1}{2} \sqrt{\frac{{μ}_{\text{?}}}{ρ \text{?}} \text{?}} ,$$
$$\text{?} \text{indicates text missing or illegible when filed}$$
μ₀=4×10⁻⁷ H/A is magnetic permeability; and
the first derivatives of the time t are respectively obtained for the horizontal electric field eₓ and the vertical induced voltage v_{z}:
$${{e}^{\text{?}}}_{\text{?}} = \frac{\partial {e}_{\text{?}}}{\partial \text{?}} = \frac{Ids}{{π}^{3 / 2}} \cdot \frac{ρ}{{r}^{3}} \cdot \frac{1}{t} \cdot {u}^{\text{?}} \cdot {e}^{\text{?}}$$
$${{v}^{\text{?}}}_{z} = \frac{\partial {v}_{\text{?}}}{\partial \text{?}} = - \frac{Ids}{{π}^{3 / 2} {μ}_{0}} \cdot \frac{y ρ}{{r}^{5}} \cdot 2 {u}^{\text{?}} \cdot {e}^{\text{?}} \cdot \frac{1}{\text{?}} ,$$
$$\text{?} \text{indicates text missing or illegible when filed}$$
wherein ėₓ is the first derivative of the time t for the horizontal electric field eₓ, and \dot{v}_{z} is the first derivative of the time t for the vertical induced voltage v_{z}.

4. The electrical source transient electromagnetic data imaging device according to claim 3, wherein the second calculation module uses a ratio of the ėₓ to the \dot{v}_{z} to calculate full-period resistivity,
$$ρ = \frac{y}{2 \text{?}} \cdot \vert \frac{{{e}^{\text{?}}}_{\text{?}}}{{{v}^{\text{?}}}_{\text{?}}} \vert .$$
$$\text{?} \text{indicates text missing or illegible when filed}$$

5. An electrical source transient electromagnetic data imaging system, comprising a memory and a processor, wherein a computer program run by the processor is stored in the memory, and the computer program executes the electrical source transient electromagnetic data imaging method according to claim 1 when the computer program is run by the processor.
